(19) United States
(12) Patent Application Publication
(10) Pub. No.: US 2013/0129310 A1
(43) Pub. Date: May 23, 2013

(54) ELECTRONIC BOOK

(71) Applicants: Alexander Shustorovich, New York, NY (US); Olga Zakharova, Moscow (RU)

(72) Inventors: Alexander Shustorovich, New York, NY (US); Olga Zakharova, Moscow (RU)

(73) Assignee: PLEIADES PUBLISHING LIMITED INC., New York, NY (US)

(21) Appl. No.: 13/346,648

(22) Filed: Jan. 9, 2012

Related U.S. Application Data
(60) Provisional application No. 61/562,827, filed on Nov. 22, 2011.

(51) Int. Cl. H04N 5/775

(52) U.S. Cl. 386/230; 386/E05.002

(57) ABSTRACT

Apparatus, system and methods provide a first screen that displays interactive content and a second screen that displays media content corresponding to portions of the text. The interactive content includes text and contextual references that operate as links to the media content displayed on the second screen. The contextual references provide video, graphical illustration, voice, text and/or interactive media in order to further enhance and complement the portions of the interactive content in the first display. Various resources enable creation of the media content and/or the interactive content in order to further provide historical descriptions, pictures, videos, contemporaneous writings and so on that complement the text of the book by providing further content. Resource inputs from various device components are compiled and used to playback an interactive experience for a user.

### PRIORITY CLAIM

This application claims priority to U.S. Provisional Patent Application Ser. No. 61/562,827, filed on Nov. 22, 2011, entitled “Electronic Book.” The entirety of the aforementioned application is incorporated by reference herein.

### TECHNICAL FIELD

This disclosure relates generally to an electronic book for an educational environment.

### BACKGROUND

When reading a book, fiction or non-fiction, readers can often lack the proper context in which to fully grasp the nuances of the text. This is especially true when the book was written long ago, or was written for an audience with different social and cultural experiences. Writers will often unconsciously assume that audiences are familiar with the same experiences and knowledge as themselves. Even though the text itself may not explicitly reference customs, mores, or events, they are often implicitly referred.

Contemporaneous writings and descriptive non-fiction such as historical and cultural commentaries can fill in the gaps of knowledge, but require the reader to spend time researching and discovering what content is relevant. If the reader has limited knowledge or experience with the social and cultural background, the reader may not even know what subjects are relevant to understanding the text, limiting the usefulness of the research.

Doing external research while reading through a text can inhibit a seamless reading experience as the reader switches between different books and resources. Searching for relevant information can also take a long time, possibly inducing the reader to cease researching, which in turn decreases the understanding the reader has of the text.

The above-described deficiencies of contextualizing written texts are merely intended to provide an overview of some problems of current technology, and are not intended to be exhaustive. Other problems with the state of the art, and corresponding benefits of some of the various non-limiting embodiments described herein, may become further apparent upon review of the following detailed description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

In various non-limiting embodiments, systems and methods are provided for a device that has a dual screen view for interactive content. In an example embodiment, a device comprises a processor and a first display portion having a first display configured to display interactive content having text and contextual references that correspond to a portion of the interactive content. The device also comprises a second display portion, communicatively coupled to the first display portion, and having a second display configured to provide media content that corresponds to the portion of the interactive content having the contextual references. A compiling component is configured to receive input from one or more multimedia resources. A creation component configured to create at least a portion of the interactive content and the media content in response to the input received from the one or more multimedia resources. A playback component configured to record and generate the interactive content and the media content. The device further comprises a computer-readable medium storing instructions that, in response to facilitation of execution by the processor, cause the device to implement at least one of the compiling component, the creation component or the playback component.

In another exemplary embodiment, a system comprises a processor, a content view generator configured to display interactive content having text and contextual references that correspond to portions of the text in a first display. A media generator is configured to display media content in a second display in response to an input received at an interface, wherein the media content complements the portions of the text that the contextual references correspond to with at least one of graphical illustration, video, voice, text and interactive media. A compiling component is configured to receive multimedia input from one or more multimedia resources. A creation component is configured to create at least a portion of the interactive content and the media content in response to the multimedia input received from the one or more multimedia resources of the system. A playback component is configured to record and generate the interactive content and the media content. The system further includes a computer-readable medium storing instructions that, in response to facilitation of execution by the processor, cause the system to implement at least one of the content view generator, the media generator, the compiling component, the creation component or the playback component.

In another exemplary embodiment, a method comprises generating, by a computing device including at least one processor, interactive content having text in a first display with a touch screen interface. Media content is generated that corresponds to different portions of the text and complement the different portions with corresponding video, graphical illustration, voice, text or interactive media in a second display located adjacent to the first display. One or more multimedia resource inputs are received from different multimedia resources and storing the one or more multimedia resource inputs in a data store as additional media content. A portion of the interactive content or additional interactive content is associated with the additional media content in response to the one or more multimedia resource inputs being received from the different multimedia resources.

In yet another exemplary embodiment, a system comprises means for generating, by the system including at least one processor, interactive content having text in a first display with a touch screen interface, and means for generating media content that correspond to different portions of the text and complement the different portions with corresponding video, graphical illustration, voice, text or interactive media in a second display located adjacent to the first display. The system further includes means for receiving one or more multimedia resource inputs from different multimedia resources and for storing the one or more multimedia resource inputs in a data store as additional media content, and means for associating, in response to the one or more multimedia resource inputs being received from the different multimedia resources, portions of the interactive content or additional interactive content with the additional media content.

The following description and the annexed drawings set forth in detail certain illustrative aspects of the disclosed subject matter. These aspects are indicative, however, of but a few of the various ways in which the principles of the innovation may be employed. The disclosed subject matter is intended to include all such aspects and their equivalents. Other advantages and distinctive features of the disclosed subject matter will become apparent from the following detailed description of the innovation when considered in conjunction with the drawings.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is a diagram illustrating an example, non-limiting embodiment of an interactive electronic device;

FIG. 2 is a diagram illustrating an example, non-limiting embodiment of a screen of an interactive electronic device;

FIG. 3 is a diagram illustrating an example, non-limiting embodiment of a screen of an interactive electronic device;

FIG. 4 is a diagram illustrating an example, non-limiting embodiment of an interactive electronic book in marked mode and unmarked mode;

FIG. 5 is a block diagram illustrating an example, non-limiting embodiment of a device for displaying interactive content on display screens of an interactive electronic book;

FIG. 6 is a block diagram illustrating an example, non-limiting embodiment of a system that provides tools for an interactive electronic book;

FIG. 7 is a block diagram illustrating an example, non-limiting embodiment of a system for creating interactive content with media content on an interactive electronic device;

FIG. 8 illustrates a flow diagram of an example, non-limiting embodiment of a method for displaying interactive content an interactive electronic device;

FIG. 9 illustrates a flow diagram of an example, non-limiting embodiment of a set of computer readable instructions for displaying interactive content and media content on an interactive electronic device;

FIG. 10 is a block diagram illustrating an example networking environment that can be employed in accordance with the claimed subject matter; and

FIG. 11 is a block diagram illustrating an example computing device that is arranged for at least some of the embodiments of the claimed subject matter.

### DETAILED DESCRIPTION

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

As an overview of the various embodiments presented herein, to correct for the above identified deficiencies of reading books that are written with different social and cultural contexts than the readers are familiar with, various systems and methods of using an interactive electronic device (e.g., electronic book or education device) are described herein to help provide proper contextualization with expanded functionalities. The interactive device provides various functional capabilities including playback, compiling, and composite interactive content (CIC) media, which defines a totality of interactive sources of information. These interactive sources, for example, represent different information types (e.g., video, graphic, text, multimedia, and interaction, etc.), and the structure of their interactions (as changes in organization and/or representations depending on user actions) within presented interactive contents. Composite interactive content also includes interactive books, magazines, textbooks, catalogs, and other modern forms of information organization and representation, as well as interactions with the information. Thus an electronic device provides functional capabilities and a set of components that make it possible to playback, compile, and create composite interactive contents.

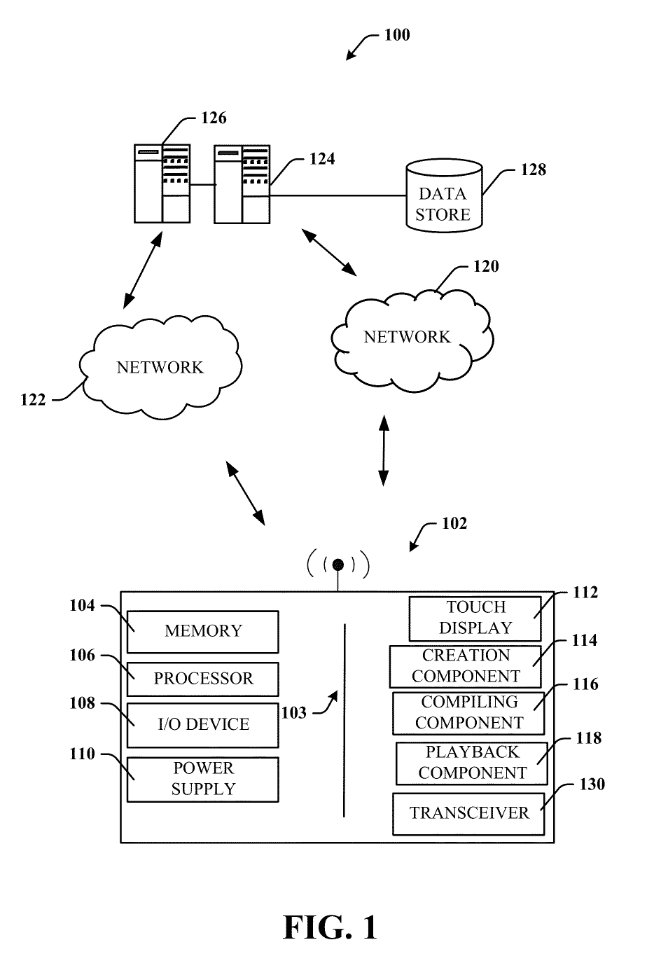

Turning now to FIG. 1, a diagram illustrating an example, non-limiting embodiment of an interactive system 100 is shown. A client device, such as a computer device 102 comprises a memory 104 for storing instructions that are executed via a processor 106. The computer device 102 includes an input/output device 108, a power supply 110, and a touch screen interface display 112. The system 100 further includes a creation component 114, a compiling component 116, a playback component 118 and a transceiver 130. The system 100 and computer device 102 can be configured in a number of other ways and may include other or different elements as can be appreciated by one of ordinary skill in the art. For example, computer device 102 may include one or more output devices, modulators, demodulators, encoders, and/or decoders for processing data.

The device 102 may include an electronic reader device, a mobile device for reading documents in the display 112, or other like electronic device, such as a wireless laptop, mobile phone, or the like. Interactive content presented in the display 112 of the device 102 include any digital document having text and/or graphic images therein, such as books, novels, journals, newspapers, articles, online articles or a compilation of web-pages, digitally copied manuscripts or any other like digital medium that presents textual and/or graphic images to a user/reader.

A communication bus 103 permits communication among the components of the device 102. The processor 106 includes processing logic that may include a microprocessor or application specific integrated circuit (ASIC), a field programmable gate array (FPGA), or the like. The processor 106 may also include a graphical processor (not shown) for processing instructions, programs or data structures for displaying a graphic and a text.

The memory 104 may include a random access memory (RAM) or another type of dynamic storage device that may store information and instructions for execution by the processor 106, a read only memory (ROM) or another type of static storage device that may store static information and instructions for use by processing logic; a flash memory (e.g., an electrically erasable programmable read only memory (EEPROM)) device for storing information and instructions, and/or some other type of magnetic or optical recording medium and its corresponding drive.

The touch screen interface display 112 accepts touch inputs from a user that can be converted to signals used by the computer device 102, which may be any processing device, such as a personal computer, a mobile phone, a video game system, or the like. Input data from touch screen interface display 112 is communicated to processor 106 for processing to associate the touch coordinates with information displayed on the touch display 112. The touch screen interface display 112 includes one or more touch screen displays. In one embodiment, one touch screen display is an electronic paper screen that imitates the appearance of ordinary ink on a digital screen. The electronic paper display does not require to be refreshed constantly and reflects ambient light rather than emitting light as a source of light, such as with an electrophoretic display, an electrowetting display, or other bistable display, for example. In addition, the touch screen interface display 112 includes another second display, which uses thin-film transistor (TFT) technology to improve image quality (e.g., addressability, contrast).

Input device 108 may include one or more mechanisms in addition to the touch display 112 that permit a user to input information to the computer device 100, such as microphone, keypad, control buttons, a keyboard, a gesture-based device, an optical character recognition (OCR) based device, a joystick, a virtual keyboard, a speech-to-text engine, a mouse, a pen, voice recognition and/or biometric mechanisms, etc. In one implementation, input device 108 may also be used to activate and/or deactivate the touch screen interface display 112. The input device 108 may also include a storage or communication port, such as a USB drive, internet connection or the like for downloading readable interactive content or documents having text and/or graphic imagery therein.

The computer device 102 can further provide a graphical user interface as well as provide a transceiver platform 130 for a user to make and receive telephone calls, send and receive electronic mail, text messages, play various media, such as music files, video files, multi-media files, games, and execute various other applications. The transceiver 130 is operable to communicate with and exchange signals by receiving and transmitting to via a network 120 and/or a network 122 one or more servers 124 and 124. Each server 124 and/or 126 could have a data store 128 for storing and controlling data items. The networks 120 and 122 include telephone radio networks and/or satellite networks respectively that enable various forms of communication of multimedia, such as voice, video, text, telephone, radio, internet, broadcast television, and the like.

The device 102 is operable to receive a source of interactive content either from the networks 120, 120, the input device 108, memory 104, other external or internal sources of content, such as from external storage devices or the like. The interactive content is displayed by the display 112. The display 112 can consist of a dual display have different view panes therein. In one embodiment, a first display view pane could provide textual content of the interactive content for a reader to read, such as a book, or some other information document. In a second display view pane, the processor 106 (e.g., a graphical processor) generates media content that corresponds to the text provided in the first display.

Components in the device enable an interactive reading experience that complements a portion or section of text, in which the reader reads. For example, a reader could be perusing a biology text book within the first display that may have been distributed to the reader from a professor or purchased online from a store. A particular section provided in the first display, for example, is text describing the process of cell division, beginning with interphase, following through cytokinesis, and the mechanisms involved with each phase of cell generation. A graphical illustration or other media content is referenced by contextual references from within the section of the content involving cell division. The contextual references become activated automatically as the reader views the corresponding section of the text or in response to input being received at the device 102. Once activated the contextual reference generate media content that enhances corresponding portions of the interactive text. The media content thus supplements a reading experience by complementing the text being read, in which contextual references footnote or reference to.

Graphical illustrations as well as different forms of media content simultaneously complement the textual material displayed in one display view and the reading experience is further able to be created according to each user's preferences. For example, one teacher of the book could provide contextual references and create individualized media content in order to better cater to and address each student or classroom needs. A father might create a reading experience that demonstrates his meaning of a poem to a child through contextual references linking various interactive and dynamic media content. The creation component 114, the compiling component 116 and the playback component 118 are communicatively coupled to provide an interactive generation of different forms of interactive content for a reader, and enable creating and sharing of different reading experiences to be cherished, instructive and/or chronicled. For example, a teacher, parent, entrepreneur or other entity may wish to generate his or her own text with accompanying media content including video, text, voice, broadcast, internet sites, interactive content and the like, giving a dynamic experience of text combining media content.

The playback component 118 is configured to playback interactive content generated or created with various resources available over the networks 120, 122, memory 104, processor 106, various input/output devices 108, etc., in order to playback the organizational structure of all the contents (e.g., text, images), and interactions with interactive content (e.g., media content accessed, contextual references shared, links, quiz or question responses, voice interactions, etc.).

The compiling component 116 is configured to secure the resources and functional components for establishing interrelations between individual multimedia resources located in the device and/or external media connected to the device, and further provide an overall organizational structure of the interactive content and the complex of multimedia resources. For example, where the input/output device 108 includes a microphone, a voice or acoustic recording could be captured and linked with a contextual reference to a portion of the text. The voice recording could then be generated according to an input received at this portion of the text, such as a finger, eye, stylus or other input. Alternatively, an automatic generation may occur in an automatic media generation mode of the processor so that as the text is presented, the voice recording corresponding to this particular portion of the text is automatically generated as well.

The creation component 114 is configured to securing all the functions and components of the device 102 to make it possible to generate individual multimedia resources and their complexes that subsequently comprise the composite interactive content. Various resources involving external resources, internal resources and a complexity of interfaces providing flexibility to creation of the reading experience are integrated through the creation component 114

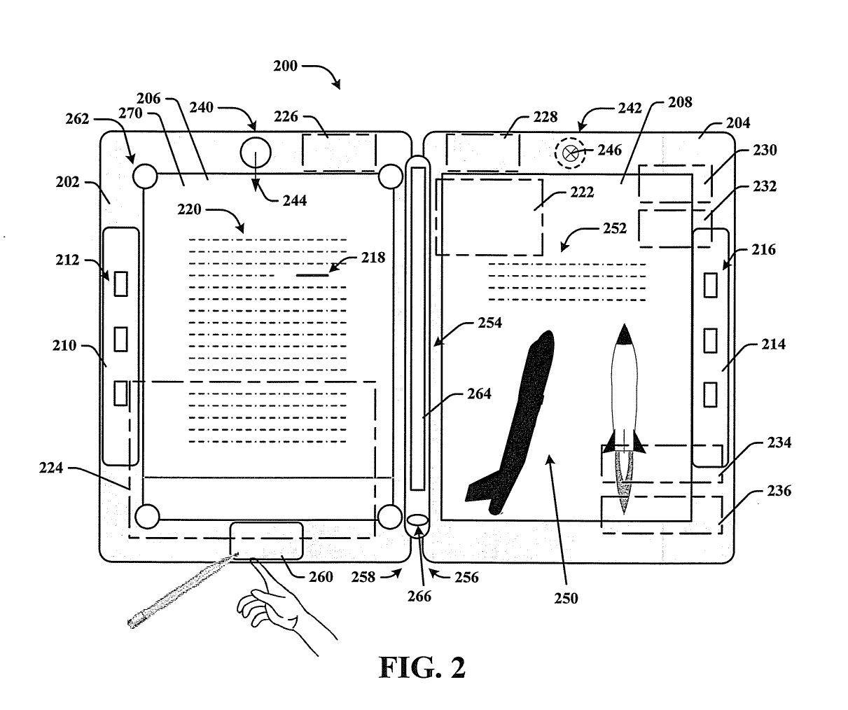

FIG. 2 illustrates one aspect of an exemplary embodiment for device 200 that provides an interactive reading experience, such as an electronic interactive reader, electronic book, palm device or the like. The device 200 includes first display portion 202 and a second display portion 204. The first display portion 202 houses a first display 206 and the second display portion houses a second display 208. The first display portion 202 includes a first interface 210 having navigation and menu controls 212. The second display portion 204 includes a second interface 214 having navigation and menu controls 216. The first interface 212 and the second interface 214 is a software and/or or hardware interface having the navigation and menu controls 212 and 216, respectively, as digital icons, links, settings, mechanical knobs, buttons, switches, and the like. The navigation and menu controls 212 and 216 interface interactive content 220 with text/graphics and contextual references 218, which may be within or alongside the textual content displayed as highlighted portions, links, footnotes, references, symbols, icons, etc. in order to reference a portion of the interactive content 220.

The device 200 includes at least one microprocessor 222, controller, central processing unit (CPU), graphics processor or the like to carry out instructions for operations within the first and second displays 206 and 208. A power supply unit 224 includes a voltage supply to power the device 200 and various components. The device 200 includes a communication module or modules 226 and 228 for exchanging data or data signals over a network, such as a satellite, radio network and the like. The communication modules 226 and 228 may be separate receiving and transmitting modules or a combined transceiver for exchanging data with outside sources of data.

The first display portion 202 and the second display portion 204 include one or more image capturing devices 240 and 242 (e.g., video, camera devices) as multimedia resources for providing an image or video inputs to a creation component 234 and a compiling component 236. In one embodiment, the image capturing device 240 is internal to the device 200 and captures images (video or still imagery) in front of the first display 206 and within a frontal view 224 of the first display portion 202. The image capturing device 242 is an external device that captures images also that reside within a rear view 246 of the second display portion 204. Additional resources are also communicatively coupled to the creation component 234 and the compiling component 236, and can be configured in a number of different architectures.

A motion sensor 230, such as an accelerometer senses motion inputs to the device 200. For example, a movement, vibration, orientation, inclination, angle and/or acceleration to the device are sensed at the motion sensor 230. The device 200 further includes a playback module 232 that is configured to record and playback the interactive content 220 and media content 250 created with the creation component 234 or received from a memory, communication modules 226, 228, external drives or other source of content including text, music, video, graphic, voice, etc. The device 200 has various interface controls for controlling multimedia resources that are generated within the first display 206 and/or the second display 208 in order to interact with the interactive text 220, the contextual references 218, and/or the media content 250, which includes text 252, graphical imagery, video, voice, interactive media that correspond to portions of the interactive content 220 linked by the contextual references 218.

The first display portion 202 and the second display portion 204 are coupled to one another via a pivoting joint 254. The first display portion 202 has a first side 258 joined to the pivoting joint and the second display portion 204 has a second side 256 joint to the pivoting joint adjacent to the first side. The pivoting joint 258 is configured to rotationally pivot the first display portion 202 with respect to the second display portion, and pivot the second display portion 204 with respect to the first display portion. The pivoting joint 258 enables either the first display portion 202 or the second display portion 204 to rotate around a lateral axis transverse to the device 200 along the first 258 and second sides 256, which allows for a compact and easily portable device 100. The pivoting joint 254 includes additional media resources, such as a speaker or a sound transmitter device 265 and an acoustic receiver 266 (e.g., microphone) for providing input and/or output to the interactive content 220, either for creation with the creation component 234 and/or to the playback component 232 for providing media content 250 in the second display 204.

The device 200 can be a handheld electronic device. The electronic device can include memory that can store the books and contextual references. The memory can be in the form of a hard drive, FLASH memory, or any other memory storage suitable for storing electronic books and interactive resources. The electronic device can also include a processor and graphics processor to display the text and contextual references on the screens of the device.

The device further includes one or more capacitive modules 262 that are controlled by a control interface 260. The capacitive module 262 and control interface 260 provide a surface interface to the first or second displays in order for a surface to translate a motion and a position of an indirect input to a relative position, such as via a hand or stylus at other surfaces than the displays 206, 208. The control interface 260 is operative as a switch to turn the capacitive module 262 on and off. Alternatively, the control interface 260 changes modes of the processor 222 or other graphic controller among a plurality of modes including a stylus mode and a dual interface mode. The stylus mode, for example, operates to disengage a first touch screen interface 270 of the first display 206 and allows for a handwritten input, such as with a stylus (e.g., digital ink pen) or other like device to enable digital ink to be drawn or handwritten on surfaces of the first display 206. Disengaging the touch screen interface 270 provides freedom to handwrite digital ink without disruption from touching the first display 206. The dual interface mode provides for the operation of both the touch screen interface 272 and the surface interface of the capacitive module 262 at the same time in the first display 204, wherein the touch screen interface 272 is configured to sense a direct input received on the first display 206 and the surface interface is configured to translate motion and a position of an indirect input (e.g., a stylus, hand, etc.).

In one embodiment, the first display 204 is an electronic paper screen that imitates the appearance of ordinary ink on a digital screen. The electronic paper display does not require refreshing constantly and reflects ambient light, rather than emitting light as a source of light. For example, the electronic paper display could be an electrophoretic display, an electrowetting display, other bistable display, or other electronic paper display. In addition, the touch screen interface display 208 includes another second touch screen display, which uses thin-film transistor (TFT) technology to improve image quality (e.g., addressability, contrast), such as a TFT liquid crystal display (TFT-LCD) or the like. The touch screen display of the second display 208 provides for a touch screen interface on the surface that is configured to sense a direct input received on the display, such as with a finger-sensitive control and stylus control.

It is to be appreciated that while FIG. 2 shows that the computing device (e.g., electronic book 200) has two displays, 206 and 208, other configurations are possible. For example, the device 200 can also have one graphical display that is split into two windows. An interactive electronic book 200 can also be installed and implemented on existing desktop and laptop computers.

In some embodiments, interactive electronic book 200 can be folded along an axis between graphical displays 206 and 208. In other embodiments, the physical configuration of interactive electronic book 200 can remain static. Graphical displays 206 and 206 can be LCD screens or can utilize electronic ink. In some embodiments, one screen can be an LCD, and the other display can use electronic ink.

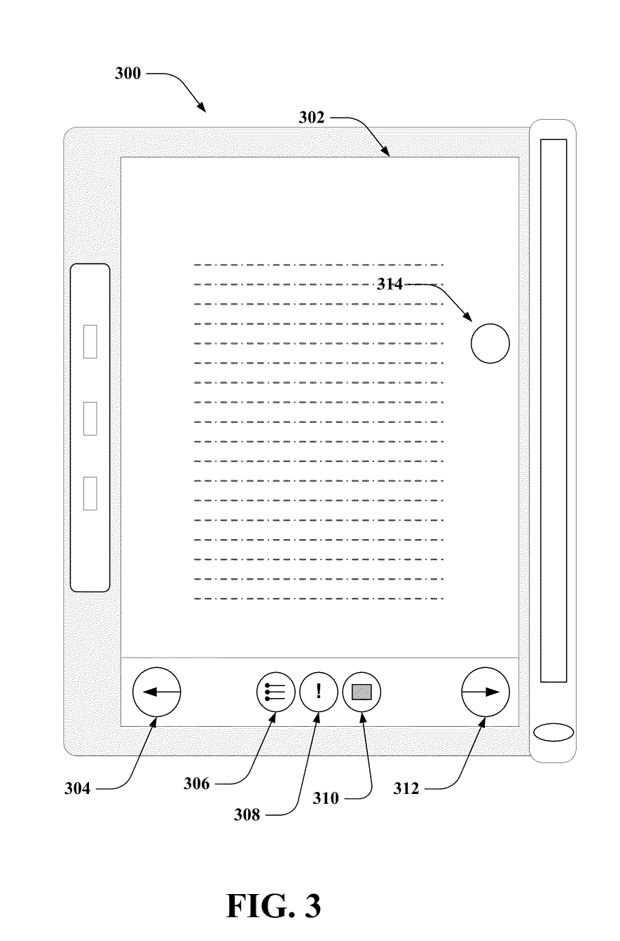

Turning now to FIG. 3, a diagram illustrating an example, non-limiting embodiment of a screen of a computing device (e.g., electronic book, smart phone reader device or the like) is shown. Computing device 300 has a graphical display 302 that is configured to display a portion of text from an electronic book. Graphical display 302 can also include controls 304, 306, 308, 310, and 312 for various menus, functions, and navigation. Contextual reference link 314 can also be provided to link to relevant references that correspond to the portion of text displayed by the graphical display 302 or an additional display.

Forward and reverse controls, 312 and 304 respectively, can be provided to navigate through the text displayed on graphical display 302. Selecting one of controls 304 or 312 can change the page of text, or can scroll through the text in the desired direction.

Table of contents control 306 can link to the table of contents for the electronic book. The table of contents can provide a list of chapters of the electronic book, as well as list the resources used as contextual references. The resources can be listed as they appear in the text, or can be listed by subject matter content, or can be grouped into text resources, audio resources, video resources, or picture resources. The table of contents can also list testing resources for the computing device.

Control 308 can be provided to link to the text located in the electronic library. Control 310 can be provided to toggle between different modes of a plurality of modes (e.g., a marked, an unmarked mode, acoustic receive mode, acoustic transmit, stylus mode, dual interface mode, a playback mode, automatic media generation mode, interface media content generation mode, a media content disengagement mode).

Contextual reference link 314 can link to one of the text, audio, video or picture references that are relevant to the text being displayed on graphical display 302. Contextual reference link 314 can be located in a vertical column next to the displayed text, and can be located at a level that corresponds to the portion of text. It is to be appreciated that while FIG. 3 shows one contextual reference link 314, more than one link can be placed in the column. For instance, if text displayed on graphical display 302 has four portions of text that have explanatory contextual references, then four links to the contextual references can appear in the vertical column next to the text.

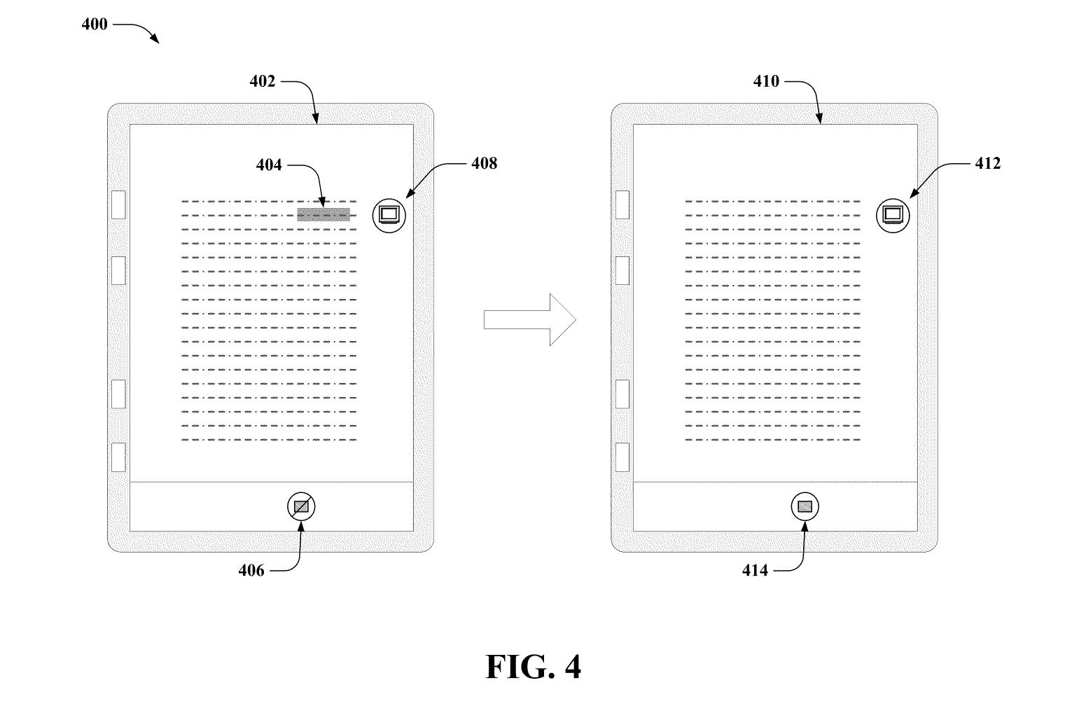

Turning now to FIG. 4, a diagram illustrating an example, non-limiting embodiment of a computing device 400 in marked mode and unmarked mode is shown. Diagram 400 shows graphical display 402 with text highlighted in marked mode, and graphical display 410 shows the text in unmarked mode.

In marked mode, the portion of text that corresponds to a contextual reference 404 can be marked to make it easier to see what part of the text that the contextual reference enhances with corresponding media content. Media content therefore is displayed upon activation of the marked mode that enhances the portion of the text that the contextual reference corresponds to. The media content is display, for example, in a separate display or in the same display and includes voice, text, music, video, graphical illustration or interactive media content, such as multimedia with quizzes, questions, selections, etc., that a reader can interface with and obtain responses in return. The text or contextual reference can be highlighted, the color, size or style of the font can be changed, or the text can be underlined to distinguish the text in marked mode. To mark the text, any change to the text that makes it distinguishable from the surrounding unmarked test can be done.

The link to the contextual reference 308 can be provided next to the marked text 404. The link 408 can identify what type of contextual reference is being linked to. Different icons can be used to identify video resources, audio resources, textual resources, picture resources and other interactive content resources.

Toggle 406 can be provided to switch between marked and unmarked mode. In unmarked mode, the toggle 414 can be displayed differently to distinguish between the different modes. For example, in FIG. 4, toggle 406 in marked mode, is displayed with a line through the toggle button to indicate that selecting that button will switch to unmarked mode. In unmarked mode, toggle 414 can be displayed without a line through it to indicate that selecting that mode will switch to marked mode.

In unmarked mode, graphical display 410 continues to display a link to contextual reference 412 even when the text is unmarked. In the unmarked mode, for example, media content is displayed as readers provide a touch input, in timed sequence after a predetermined amount of time, based on an eye path, or some other input. In other modes, the interactive content can be controlled, disengaged or made to be automatic, such as in automatic media generation mode, interface media content generation mode, a media content disengagement mode, for example.

While FIG. 4 shows one contextual reference link besides the text, any number of contextual reference links is possible. For instance, if the text displayed on graphical display 402 or 410 has five portions of text with corresponding contextual references, five links to contextual references can be displayed in the vertical column besides the text, at heights corresponding to the location of the portion of text relative to the rest of the text.

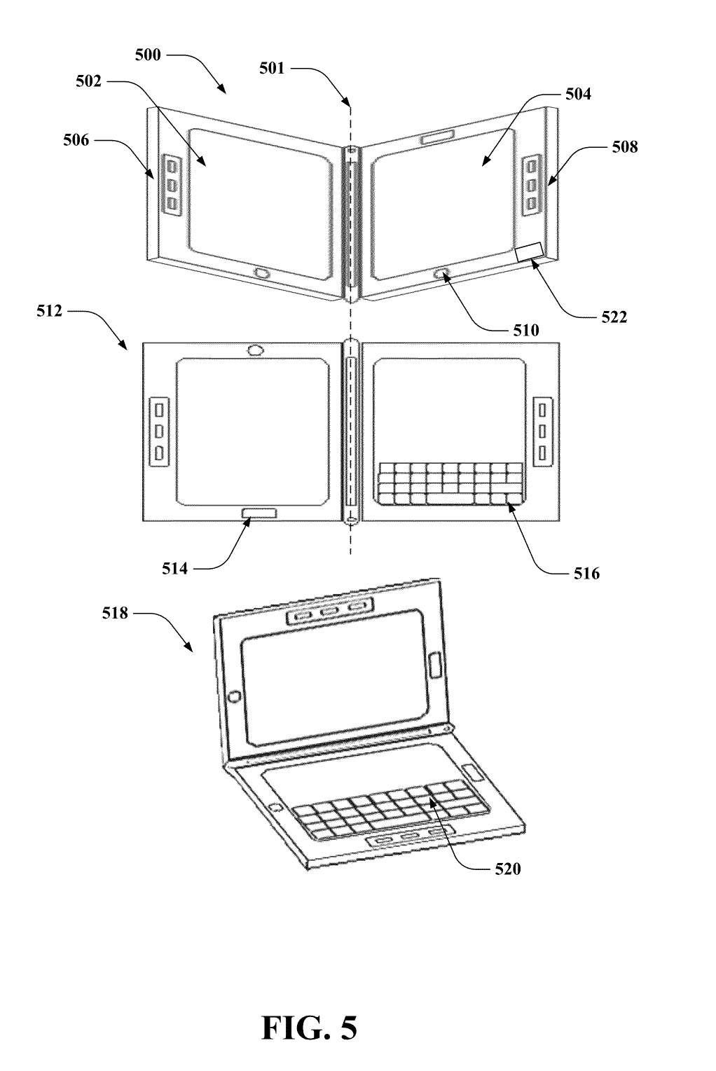

Referring now to FIG. 5, illustrated is an electronic device 500 in various orientations. The device 500 is configured to provide text in a first display 502 having a touch screen interface controls on the surface of the display and configured as an electronic paper display. The device 500 further provides media content in a second display 504 including text, video, voice and other interactive media, such as through telephone conversation, texting, video streaming, voice streaming, quizzes, etc., which may be related to the text in the first display 502. The second display 504 also provides a touch screen interface for sensing a direct input at the surface, such as provided with a digit of a hand, and is configured as a resistive surface, such as a TFT display, for example. The device 500 further includes a virtual keyboard control 510 that generates a virtual keyboard 516 and orients the keyboard according to a motion sensor input received from a motion sensor 522.

In one embodiment, the first display 502 has an interface 506 and the second display 504 has an interface 508 for manual or further software controls, such as for a controlling the text and media content respectively. In addition, the first display 502 and the second display 504 are configured to rotate around an axis 501 that extends laterally according to the sides of the first and second displays. The device 500, for example, includes a casing having a first portion and a second portion with respective first and second displays 502, 504 that are two flexible parts. The pivot joint between the two parts ensures alteration of the relative position with respect to each display at 90 degrees, 180 degrees, 270 degrees, for example. Other rotation angles are also envisioned for rotation around the axis 501.

The device 500 further shows an orientated device 512 at a different angle than shown above it. The device 512 further includes a surface area 514 for providing an indirect interface with a stylus or other device for providing input to the first display 502. In another embodiment, the device 500 is an orientated device 518 where the motion sensor 522 has sensed a motion and/or an angle of the device displays and communicated to the virtual key board control 510 to generate a virtual keyboard within the display at an upright angle based on the orientation or motion of the device 500. The virtual keyboard 520 generated in the second display 504 could also be generated in the first display and is not limited to any one display or position.

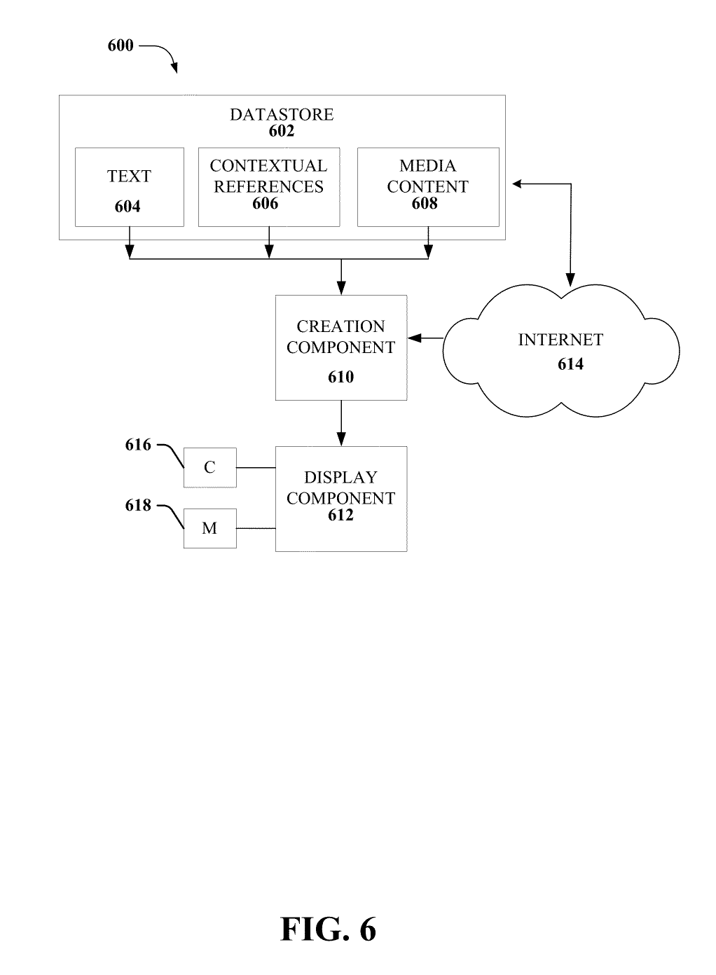

Turning now to FIG. 6, a block diagram illustrating an example, non-limiting embodiment of a system 600 for displaying text and contextual references on the screens of an interactive electronic device or book is shown. System 600 can include a datastore 602 that is configured to store text 604, contextual references 606 and/or media content 608. A creation component 610 is provided to select one or more contextual references 606 that correspond to a portion of text 604, and associate media content 608 to the portion, such as voice, video, text, and other interactive media. A display component 612 can be provided to display the portion of text 604 and the contextual reference 608 on a graphical display. In other embodiments, the datastore 602 includes media content 608 for display in conjunction with the text 604 and contextual references 606 associated to the text. The text 604, contextual references 606 and associated media content 608 combine to form an interactive reading experience that is able to dynamically update or be created by user, such as an instructor, professor, teacher or a recreational user, for example.

The datastore 602 can be in the form of a hard drive, FLASH memory, or any other memory storage suitable for storing electronic books and interactive resources. In some embodiments, datastore 602 can be on the electronic device, and in other embodiments, datastore 602 can be remotely located. When datastore 602 is remote, it can be stored in the cloud, and accessed via the internet. Data services on the electronic device such as WIFI, 4G, 3G, or other communication protocols can be used to access the remote datastore 602.

Text 604, stored on datastore 602, can be a portion of, or an entire electronic book having multiple sections or portions within. Text 604 can also be multiple electronic books at once stored in the datastore 602. The electronic books can be downloaded or installed by a user, such as via an internet 612, or can alternatively come with the interactive electronic book when it is purchased and thus be preinstalled. Contextual references 606 can be a library of resources that are related to text 604. The resources can include video, audio, textual, or pictorial resources that can explain, and contextualize the text.

As an example, if a fiction book set in the past in a foreign country is stored in text 604, contextual references 606 can provide activation to media content 608 that explains or further illustrates more information about that time period, country, cultures, etc. For instance, the contextual references 606 link to such information as documentary videos, pictures of towns, historical writings, and social and cultural commentary that provides information about the time period and location. Such information can provide a better understanding of the text 604, helping the reader to visualize the setting and grasp the nuances in the text more clearly.

The creation component 610 is configured to associate media content 608 with a contextual reference 606, or vice versa, from the set of contextual references that corresponds to a portion of the text 604. A library of multimedia resources can be provided by the creation component 610 that aid in designing media content 608 that is somewhat relevant to the entire text of the electronic book, but specific items from the library of resources might hold special relevance for certain portions of the text 604. For instance, if a particular location or event is mentioned in the text of the fiction book, items from the library of resources that pertain to the location or event are particularly relevant to that portion of text. The same item may also be relevant to other portions of text, and similarly, the portion of text can be linked to many different items from the resource library. Various multimedia resources, for example, could be provided from the creation component 610, such as presentation applications, editing tools, acoustic input control from an acoustic input device, graphic manipulation tools (e.g., Photoshop and associated tools), sound manipulation controls, image enhancements, music, video, touch input controls, contextual references within the media content to further enhance the media content, and the like.

In one embodiment, the creation component 610 can be configured to select relevant contextual references 606 based on associations made manually. In this embodiment, when the text of the electronic book and the resources are downloaded or installed, the contextual references and the portion of the text the references corresponding there to, can have been pre-associated. In other embodiments, the media content component 608 can generate associations between the text and the resources automatically. The media component 408 can automatically generate the associations based on context, relevance, past actions, pattern matching, or other artificial intelligence techniques. In addition, online events, such as videos, interactive media, voice, text, illustrations and the like can be linked via the internet 614 and displayed in the screen as the media content 608.

In another embodiment, the creation component 610 can select multiple contextual references 606 that are relevant to portions of the text 604 or just one. A user can select which contextual reference 606 he or she would like displayed. A user can also set up a filter for certain types of contextual references 606. For instance, in response to receiving an indication that video or audio resources are preferred, the linking component 608 can select audio and video contextual references that correspond to the text accordingly. In addition, age categories could be programmed into the filter to filter out material that is marked according to a rating standard, such as rate R, violent, for teens, high risk, and the like ratings. Therefore, for children who select a Disney preference, all things Disney could be allowed and provided according to this preference.

The creation component 610 can also update the selected contextual references 606 in response to the portion of text 604 being updated. As the reader reads through the text 604, the portion of text 604 being displayed by the display component 612 thus changes. Creation component 610 can search the set of contextual references 606 to select particular references that correspond to the portion of text 604 being displayed on a screen, and continuously update the references as the text 604 changes.

In other embodiments, the text 604, the contextual references 606 and the media content 608 can be updated via an external device (not shown) or via the internet 614 or other network for downloading information. In one embodiment, the creation component 610 is configured to periodically monitor the text 604, and media content 608 and compare the information to that available online to determine whether or not the text 604 and the media content 608 are out of date. For example, the creation component 610 can determine whether a new version, edition, or translation of a book is available, and prompt the user to ask whether or not the new version should replace the current version. In other embodiments, creation component 610 can determine that new contextual references are available that can provide different contextual background of the text, and can download the new contextual references automatically.

Display component 612 is configured to display the portion of the text and the contextual reference 606 on a graphical display. Display component 612 can display both the text and the contextual references on the same display, or can display the text and contextual references on separate screens, as well as display the media content corresponding thereto. The display component 612 further includes a content view generator 616 configured to display interactive content having the text 604 and contextual references 606 that correspond to portions of the text in a first display. The display component 612 further includes a media generator 618 configured to display media content 608 in a second display in response to an input received at an interface. The contextual references 606 cam include at least one of a link, a highlight, a mark or a footnote provided within or adjacent to the text 604 of the interactive content that triggers the media generator 618 to provide the media content 608 in the second display, in response to the input, to complement the portions of the text that the contextual references correspond to respectively.

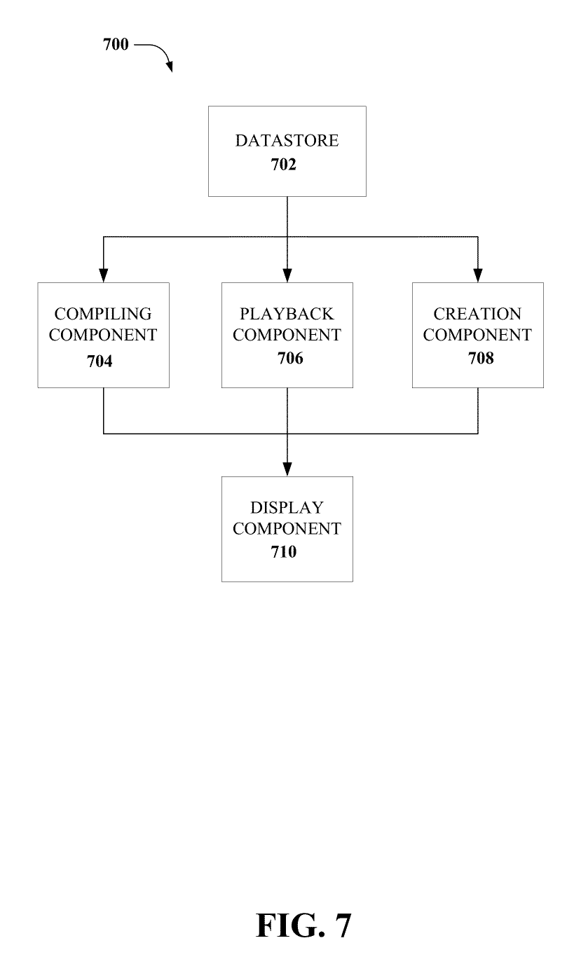

Turning now to FIG. 7, a block diagram illustrating an example, non-limiting embodiment of a system 700 that provides various tools for an interactive electronic device or book. System 700 can include a datastore 702, for example, that stores text and contextual references that are displayed on the interactive electronic book. System 700 can also include compiling component 704, playback component 706, and creation component 708, each of which can perform various functions related to the interactive electronic book. The compiling component 704, playback component 706, and creation component 708 enable designing with a composite interactive contents (e.g., books, magazines, textbooks, catalogs, etc., representing a totality of textual, multimedia, and interactive content information) with task sharing between the system 700, including search in external sources (e.g., external data media, the internet, etc.) playback and interaction with any interactive information source. The compiling component 704, playback component 706, and creation component 708 further provide functions in conjunction to independently create composite interactive contents, by compiling media with the compiling component 704, for example, and by the tools of the electronic reader system 700 including multimedia resources, such as inputting text information with handwritten stylus in a stylus mode and typed text in a virtual keyboard in a dual interface mode, for example.

Display component 710 can be configured to display the results of the functions on the screens of the interactive electronic book. In one embodiment, a display size corresponds to a size of a standard printed book page (at least 10′ diagonally), which ensures a comfortable use of an electronic reader device, or electronic book as a traditional “paper” book.

The compiling component 704 is configured to provide installing various components of the system 700 from external media and establishing links or contextual references between them, as well as providing links between generated photo, audio and video information. Compiling component 704 can be configured, for example, to generate a table of contents or other organizations of the text, contextual references, and media content associated with the text. The table of contents can provide a list of chapters of the electronic book, as well as list the resources used as contextual references. The resources can be listed as they appear in the text, or can be listed by subject matter content, or can be grouped into text resources, audio resources, video resources, or picture resources. The table of contents can also list testing resources for the interactive electronic book.

In another embodiment, the compiling component 704 can be configured to generate the table of contents by analyzing metadata associated with the text and contextual references. Metadata tags can identify the subject matter of the text and references, and identify position of the text in relationship to the rest of the electronic book. A table of contents can be generated from analyzing the metadata tags.

In another embodiment, the compiling component 704 can also be configured to provide links to the full versions of the contextual references. The references used in a library of resources can just contain small portions of other works, and the compiling component can analyze the references to determine the source of the reference. Once the source of the reference is located, the compiling component can provide a link to the full version of the references, or provide a link to where the full versions can be purchased.

Once the table of contents is generated, display component 710 can shows the table of contents on one of the graphical displays of the interactive electronic book. Links to the table of contents can also be generated and displayed in the interactive electronic book menu and shortcut bar.

Playback component 706 is configured to playback, to record and to generate the created reading experience compiled by the compiling component 704 and the creation component 708. For example, the playback component 706 is configured to generate the text in an electronic paper technology screen having lighting that imitates reading a paper with text. In addition, another screen is provided dynamic media content that needs rapid refreshing, such as in a TFT display or other display. The playback component 706 can provide an editing view that enables editing of the generating interactive content with media associated therewith and provide for a created reading experience that can no longer be edited by students or others because of security settings or proprietary license encryptions.

Creation component 708 is configured to provide features and tools to create the text, contextual references and the media content associated with portions of the text. The creation component 708 can be configured to generate interactive content such as quizzes based on the text, contextual references and media content. Tests and quizzes can be used to allow the readers to test themselves on their comprehension of the text. The tests can be based on the text, or can be based on the contextual references, in order to test how well the reader understands the context of the book. The tests can be automatically generated, or the test generation component can receive a list of questions from another source, and select a set of the questions to be used in the test. The display component 710 can display the tests when they are generated, and provide answers in response to the reader taking the test, so that the tests themselves can be used as learning tools.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

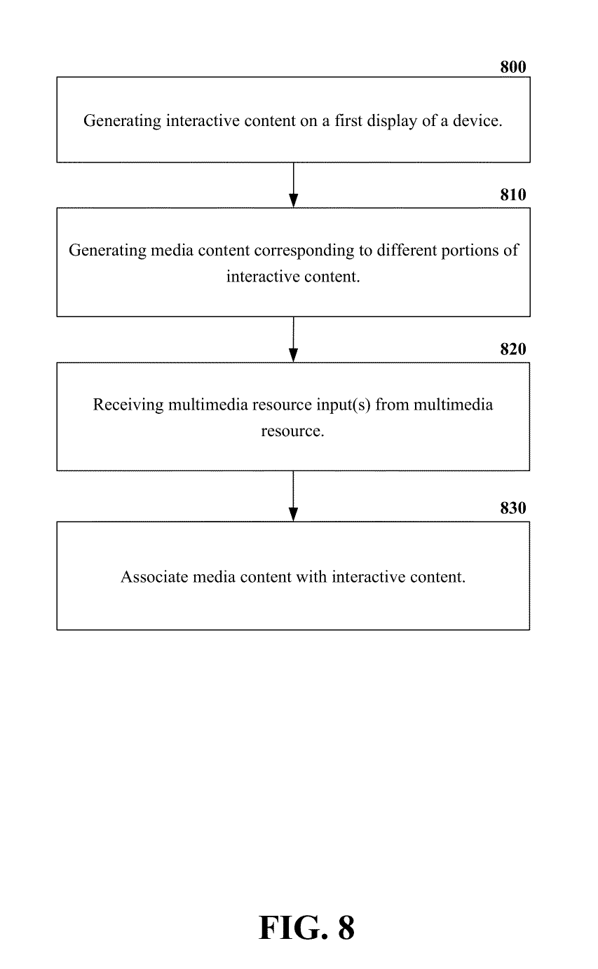

FIG. 8 illustrates a process in connection with devices or systems 100-700 of FIGS. 1-7. The process of FIG. 8 can be implemented for example by systems 100-600. FIG. 8 illustrates a flow diagram of an example, non-limiting embodiment of a method for an electronic device to generate an enhanced reading experience with a creation component, a compiling component and a playback component for displaying interactive content and media content to a reader. At 800, interactive content is displayed on a first graphical display of an electronic device. The interactive content includes text and contextual references that link to media content to supplement the text. The interactive content displayed is a portion of the contents of an electronic book or the entire electronic book. The amount of content displayed is operable to vary as font size and type are adjusted.

In one embodiment, the interactive content is displayed in first display of a dual screen device having a transceiver for communication data, signals, voice, video, and other content with a cloud server, a network, server, a mobile phone, personal computer or other digital device. For example, RF networks and satellite networks are used to communicate with other devices, networks or users to share and exchange data, such as other interactive content for a reading experience. In another embodiment, the device has media content and interactive content stored on the device. However, the media content and interactive content is also able to be created, edited, designed, stored and manipulated on the device itself. Interactive content and media content, for example, is downloaded, uploaded, and/or purchased with the device.

At 810, media content that corresponds to different portions of the interactive content (e.g., text with contextual references throughout) is generated. For example, contextual references linked to the text displayed on the electronic device are used to link media content that supplements or complements the portion of the text that the media corresponds to. The media content is displayed in as second display that has a touch screen interface operable to receive input from a finger sensitive control and a stylus control. Alongside and adjacent to the second display, the first display provides an electronic paper display that provides a view that is bistable, does not require refreshing, and imitates the lighting of a paper book reading experience by providing reflective lighting rather than a lighting source. The first display is operable to provide both a touch screen interface for activating the contextual references within the text and generate the media content alongside in the second display. The media content includes voice, text, video, and other interactive media content that complements the portion of the text in which the media content corresponds. For example, where the text is discussing the Galapagos Islands in the book “The Origin of Species,” by Charles Darwin, the media content corresponding to the text is generated to correspond to the Galapagos Islands, in which illustration, video, voice, sound, etc. corresponding to the islands is generated in the second display.

In one embodiment, the references can be contextual references that are selected from a library of resources either stored or provided in a cloud service corresponding to the particular book or text. The library of resources can be somewhat relevant to the entire text of the electronic book, but specific items from the library of resources might hold special relevance for certain portions of the text. For instance, if a particular location or event is mentioned in the text of the fiction book, items from the library of resources that pertain to the location or event are particularly relevant to that portion of text. The same item may also be relevant to other portions of text, and similarly, the portion of text can be linked to many different items from the resource library. The references that are selected are references that are particularly relevant to the text that is currently being displayed on the first graphical display.

The relevant contextual references can be selected based on metadata associated with the text and the references. Matching metadata tags can indicate that the references are particularly relevant. Selecting references can also be made automatically based on context, relevance, past actions, pattern-matching, or other artificial intelligence techniques.

At 820, multimedia resource inputs are received from one or more multimedia resources. For example, external or internal input/output devices, internet resources, cloud provider services, applications, etc. are compiled as the multimedia resources for generating an interactive text with media content in dual screen display. A compiling component combines, gathers and/or compiles these inputs, while a creation component enables the creation of them to be obtained and edited. For example, receiving the one or more multimedia resource inputs includes receiving at least one of an acoustic input from an acoustic receiver, a touch screen input from a first touch screen interface at the first display, a second touch screen input from a second touch screen interface at the second display, a first image capturing input from a first image capturing device located within a frontal view of the first display, and a second image capturing input from a second image capturing device within a rear view of the second display. Other inputs from external resources are also envisioned and no one input for generating media content or combination limits the present disclosure herein.

At 830, media content is associated with interactive content. The contextual references are displayed alongside the text, wherein the contextual references provide context about the text, and thus, complement corresponding portions of the text with media content, enhancing the reading experience. The text and the contextual references can be displayed on the same screen or on different screens. In addition, media content is also displayed in the same screen as the text, with or without contextual references. A contextual reference links to the media content that can be displayed on the same screen as the text, in a vertical column beside the text, for example, or displayed in an additional second display. Clicking on the link can initiate the displaying of the reference on the other screen, or in an automatic generation mode the contextual references or media content associated therewith can be generated automatically based on an input, such as a timing input, eye scan path, finger touch, stylus input, etc.

At 830, the text can be displayed in marked mode, wherein the text that has corresponding references is marked up. In marked mode, the portion of text that corresponds to a reference can be marked to make it easier to see what part of the text the contextual references helps to explain. The text can be highlighted, the color, size or style of the font can be changed, or the text can be underlined to distinguish the text in marked mode. To mark the text, any change to the text that makes it distinguishable from the surrounding unmarked test can be done. The text can also be displayed in unmarked mode, where the link to the reference is still displayed in the vertical column, but the text is unmarked to make it easier to read.

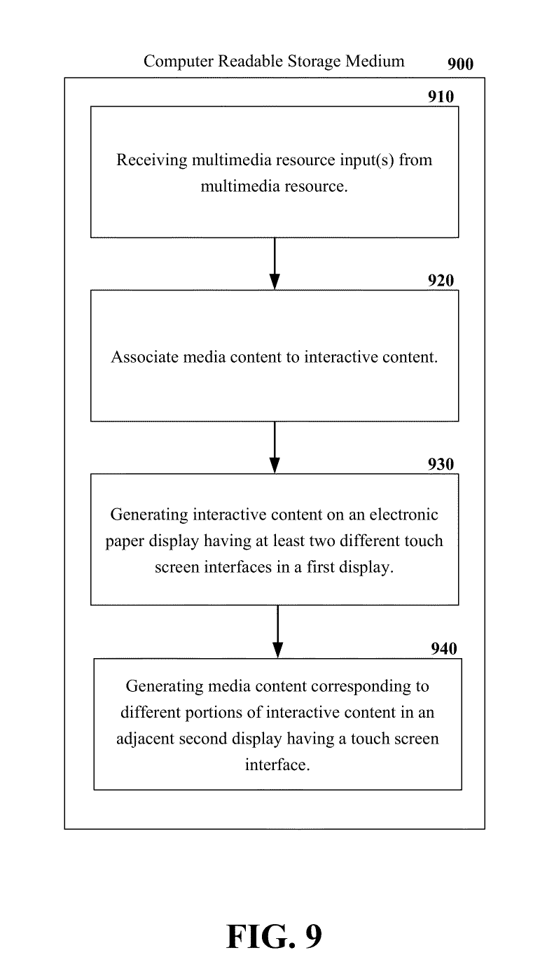

Turning now to FIG. 9, flow diagram of an example, non-limiting embodiment of a set of computer readable instructions for displaying text and contextual references on an interactive electronic book is shown. Computer readable storage medium 900 can include computer executable instructions. At 910, multimedia inputs from multimedia resources communicatively connected with the device are received for providing interactive content to a reader. A creation component provides tools to create interactive content with media content and/or edit interactive content with media content already created.

At 920, the instructions can operate to select contextual references linked to the text that is displayed on the electronic device and connect media content to correspond to the contextual references and portions of the text. The references can be contextual references that are selected from a library of resources. The library of resources can be somewhat relevant to the entire text of the electronic book, but specific items from the library of resources might hold special relevance for certain portions of the text. For instance, if a particular location or event is mentioned in the text of the fiction book, items from the library of resources that pertain to the location or event are particularly relevant to that portion of text. The same item may also be relevant to other portions of text, and similarly, the portion of text can be linked to many different items from the resource library. The references that are selected are references that are particularly relevant to the text that is currently being displayed on the first graphical display.

At 930, the instructions operate to display the references alongside the text, such as with a playback component, wherein the contextual references and associated media content provide context about the text. The text and the media content can be displayed on the same screen or on different screens. A contextual reference link to the text and media content can be displayed on the same screen as the text, in a vertical column beside the text. Clicking on the link can initiate the displaying of the reference on the other screen. The instructions operate to display text on a first electronic paper display of an electronic device, on a second display of the device, or on both displays. The first electronic paper display has at least two touch screen interfaces. For example, a finger sensitive or stylus sensitive touch screen display is configured to sense direct input to control content within the display on the screen of the display. A second touch screen display provides for a handwriting surface for writing ink at the display. The screens can operate in conjunction together or separately with the handwritten ink not being affected by the touch screen display receiving direct input. The interactive content displayed includes text of a portion of an electronic book or the entire electronic book. The amount of text displayed varies as font size and type are adjusted. In one embodiment, providing one or more contextual references within the first display links the different portions of the text to the media content, and includes at least one of a link, a highlight, a mark or a footnote provided within or adjacent to the text of the interactive content.

At 940, media content is displayed in a second display. The media content corresponds to different portions of the interactive content in an adjacent second display having a touch screen interface. In one embodiment, generating the media content that corresponds to the different portions of the text is provided in response to an input received at the first display or the second display, or in response to a playback mode of a plurality of modes including an automatic media content generation mode where inputs are received to display media content based on a timed input or other input, an interface media content generation mode where a contextual references is activated manually (e.g., touch, stylus, etc.), and a media content disengagement mode where media content is deactivated for playback.

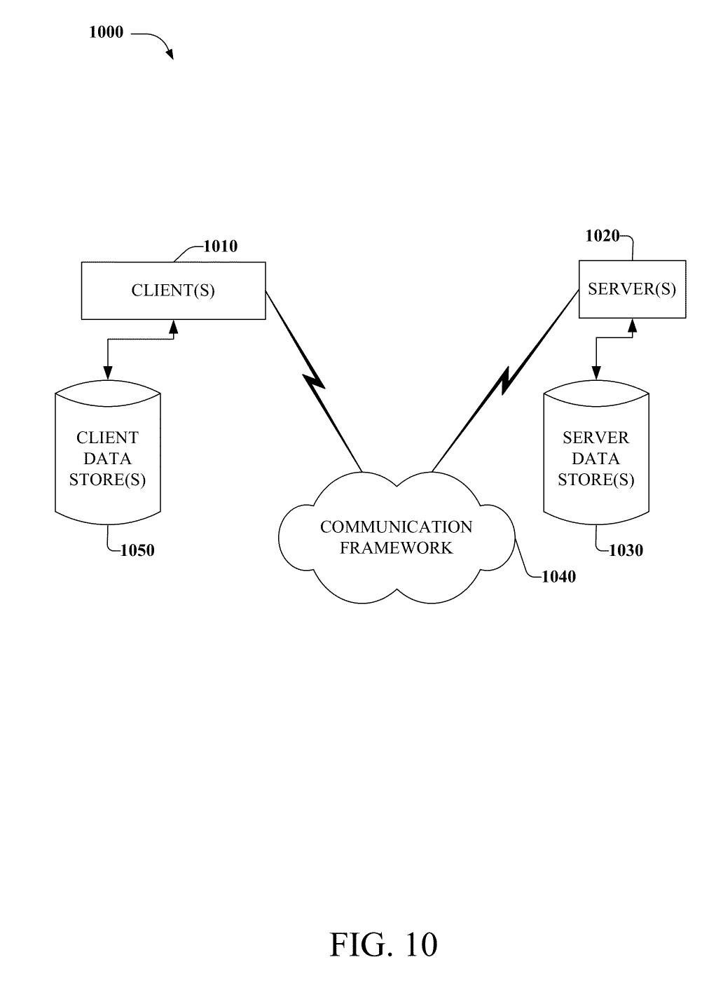

Turning now to FIG. 10 a block diagram illustrating an example networking environment that can be employed in accordance with the claimed subject matter is shown. The system 1000 includes one or more client(s) 1010. The client(s) 1010 can be hardware and/or software (e.g., threads, processes, computing devices). The system 1000 also includes one or more server(s) 1020. The server(s) 1020 can be hardware and/or software (e.g., threads, processes, computing devices). The servers 1020 can house threads to perform transformations by employing the subject innovation, for example.

One possible communication between a client 1010 and a server 1020 can be in the form of a data packet adapted to be transmitted between two or more computer processes. The system 1000 includes a communication framework 1040 that can be employed to facilitate communications between the client(s) 1010 and the server(s) 1020. The client(s) 1010 are operably connected to one or more client data store(s) 1050 that can be employed to store information local to the client(s) 1010. Similarly, the server(s) 1020 are operably connected to one or more server data store(s) 1030 that can be employed to store information local to the servers 1020.

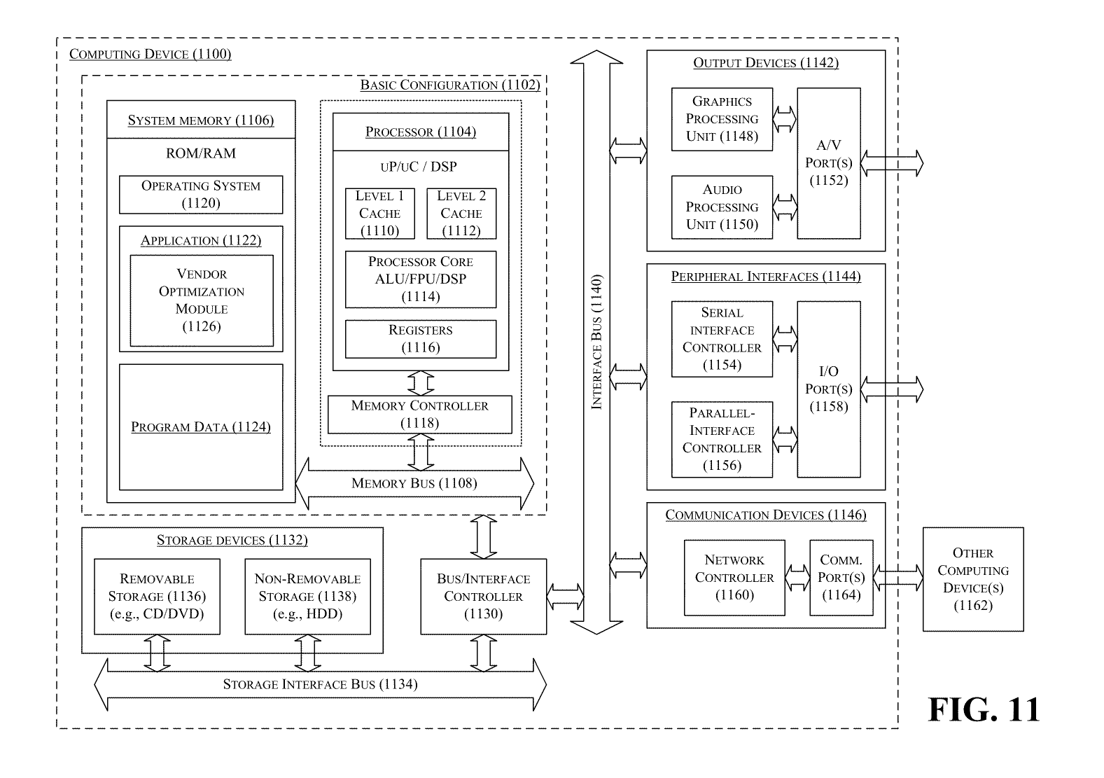

Referring now to FIG. 11, there is illustrated a block diagram of a computer operable to provide networking and communication capabilities between a wired or wireless communication network and a server and/or communication device. In order to provide additional context for various aspects thereof, FIG. 11 and the following discussion are intended to provide a brief, general description of a suitable computing environment 1300 in which the various aspects of the innovation can be implemented. While the description above is in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the exemplary environment 1100 for implementing various aspects includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 can also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1111 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is to be appreciated that the innovation can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 2394 serial port, a game port, a USB port, an IR interface, etc.

A monitor 1144 or other type of display device is also connected to the system bus 1108 through an interface, such as a video adapter 1146. In addition to the monitor 1144, a computer typically includes other peripheral output devices (not shown), such as speakers, printers, etc.

The computer 1102 can operate in a networked environment using logical connections by wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 through the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least wireless fidelity (WiFi) and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE 802.11(a, b, g, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A device, comprising:
a processor;
a first display portion having a first display configured to display interactive content having text and contextual references that correspond to a portion of the interactive content;
a second display portion, communicatively coupled to the first display portion, and having a second display configured to provide media content that corresponds to the portion of the interactive content having the contextual references;
a compiling component configured to receive input from one or more multimedia resources;
a creation component configured to create at least a portion of the interactive content and the media content in response to the input received from the one or more multimedia resources;
a playback component configured to record and generate the interactive content and the media content; and
a computer-readable medium storing instructions that, in response to facilitation of execution by the processor, cause the device to implement at least one of the compiling component, the creation component or the playback component.

2. The device of claim 1, further comprising:
a pivoting joint coupling the first display portion with the second display portion and configured to rotationally pivot the first display portion and the second display portion with respect to one another around a lateral axis that transverses a first side of the first display portion and a second side of the second display portion that is laterally adjacent to the first side of the first display portion.

3. The device of claim 2, wherein the pivoting joint comprises:
an acoustic receiver configured to sense and translate acoustic signals to the microprocessor based on a mode of a plurality of modes of the microprocessor; and
a sound transmitter configured to produce sounds based on the mode of the plurality of modes of the microprocessor.

4. The device of claim 3, wherein the first display includes an electronic paper display and the second display includes a thin film transistor display.

5. The device of claim 4, wherein the first display further includes:
a touch screen interface configured to sense a direct input received on the first display;
a surface interface configured to translate a motion and a position of an indirect input to a relative position on the first display; and
a control interface that includes a switch component configured to switch among a plurality of first display modes including a stylus mode that disengages the touch screen interface of the first display to only receive a handwritten input with a stylus and a dual interface mode that enables operation of both the touch screen interface and the surface interface.

6. The device of claim 4, wherein the first display and the second display include a touch screen interface configured to sense a direct input received on the first display and the second display respectively.

7. The device of claim 2, wherein the first display portion further includes a first image capturing device configured to capture internal images within a frontal view of the first display portion, and the second display portion further includes a second image capturing device configured to capture external images within a rear view of the second display portion.

8. The device of claim 2, further comprising:
a movement sensor communicatively coupled to the microprocessor and configured to sense an orientation, vibration, angle or movement of the device; and
a virtual keyboard component configured to provide a virtual keyboard within the first display or the second display based on a motion input from the movement sensor.

9. The device of claim 2, further comprising:
a transceiver configured to exchange signals via a radio network and a via satellite network, wherein the transceiver is further configured to exchange the interactive content and the media content that includes video, voice, graphic, text and interactive media.

10. A system, comprising:
a processor;
a content view generator configured to display interactive content having text and contextual references that correspond to portions of the text in a first display;
a media generator configured to display media content in a second display in response to an input received at an interface, wherein the media content complements the portions of the text that the contextual references correspond to with at least one of graphical illustration, video, voice, text and interactive media;
a compiling component configured to receive multimedia input from one or more multimedia resources;
a creation component configured to create at least a portion of the interactive content and the media content in response to the multimedia input received from the one or more multimedia resources of the system;
a playback component configured to record and generate the interactive content and the media content; and
a computer-readable medium storing instructions that, in response to facilitation of execution by the processor, cause the system to implement at least one of the content view generator, the media generator, the compiling component, the creation component or the playback component.

11. The system of claim 10, wherein the one or more multimedia resources include:
an acoustic receiver configured to sense and translate acoustic signals to the microprocessor;
a sound transmitter configured to produce sounds based on a mode of a plurality of modes of the microprocessor;
a first touch screen interface configured to sense a first direct input received on the first display;
a second touch screen interface configured to sense a second direct input received on the second display;
first image capturing device configured to capture internal images within a frontal view of the first display; and
a second image capturing device configured to capture external images within a rear view of the second display.

12. The system of claim 11, wherein the media generator is configured to display the media content in the second display in response to the input received at the interface that includes the first touch screen interface located at the first display having the interactive content, or in response to a playback mode of the playback component.

13. The system of claim 12, wherein the contextual references include at least one of a link, a highlight, a mark or a footnote provided within or adjacent to the text of the interactive content that triggers the media generator to provide the media content in the second display, in response to the input, to complement the portions of the text that the contextual references correspond to respectively.

14. The system of claim 13, wherein the first display and the second display are operatively connected with a pivoting joint configured to rotationally pivot the first display and the second display with respect to one another around a lateral axis that transverses a first side of the first display and a second side of the second display that is laterally adjacent to the first side of the first display.

15. The system of claim 14, wherein the first display further includes:
an electronic paper display;
a surface interface configured to translate a motion and a position of an indirect input to a relative position on the first display; and
a control interface that includes a switch component configured to switch among a plurality of first display modes including a stylus mode that disengages the first touch screen interface of the first display to receive a handwritten input with a stylus and a dual interface mode that enables operation of both the first touch screen interface and the surface interface;
wherein the second display includes a thin film transistor display.

16. The system of claim 10, further comprising:
a movement sensor communicatively coupled to the microprocessor and configured to sense orientation, vibration, angle or movement of the first display or the second display;
a virtual keyboard component configured to provide a virtual keyboard within the first display or the second display at an orientation that varies based on motion input from the movement sensor; and
a transceiver configured to exchange signals via a radio network or a via a satellite network, wherein the transceiver is further configured to exchange the interactive content and the media content.

17. A method, comprising:
generating, by a computing device including at least one processor, interactive content having text in a first display with a touch screen interface;
generating media content that correspond to different portions of the text and complement the different portions with corresponding video, graphical illustration, voice, text or interactive media in a second display located adjacent to the first display;
receiving one or more multimedia resource inputs from different multimedia resources and storing the one or more multimedia resource inputs in a data store as additional media content; and
associating portions of the interactive content or additional interactive content with the additional media content in response to the one or more multimedia resource inputs being received from the different multimedia resources.

18. The method of claim 17, wherein the receiving the one or more multimedia resource inputs includes receiving at least one of an acoustic input from an acoustic receiver, a touch screen input from a first touch screen interface at the first display, a second touch screen input from a second touch screen interface at the second display, a first image capturing input from a first image capturing device located within a frontal view of the first display, and a second image capturing input from a second image capturing device within a rear view of the second display.

19. The method of claim 17, further comprising:
providing one or more contextual references within the first display that links the different portions of the text to the media content, and that includes at least one of a link, a highlight, a mark or a footnote provided within or adjacent to the text of the interactive content.

20. The method of claim 19, generating the media content that corresponds to the different portions of the text in response to an input received at the first display or the second display, or in response to a playback mode of a plurality of modes including an automatic media content generation mode, an interface media content generation mode, and a media content disengagement mode.

21. A system, comprising:
means for generating, by the system including at least one processor, interactive content having text in a first display with a touch screen interface;
means for generating media content that correspond to different portions of the text and complement the different portions with corresponding video, graphical illustration, voice, text or interactive media in a second display located adjacent to the first display;
means for receiving one or more multimedia resource inputs from different multimedia resources and for storing the one or more multimedia resource inputs in a data store as additional media content; and
means for associating, in response to the one or more multimedia resource inputs being received from the different multimedia resources, portions of the interactive content or additional interactive content with the additional media content.
